(19) United States
(12) Patent Application Publication
(10) Pub. No.: US 2015/0197972 A1
(43) Pub. Date: Jul. 16, 2015

(54) HYDRAULIC CYLINDER IMPACT-BUFFERING ASSEMBLY

(71) Applicant: DOOR & WINDOW HARDWARE CO., Taichung (TW)

(72) Inventors: Wei-Hung CHANG, Taichung (TW); Sung-Hui LIN, Taichung (TW)

(73) Assignee: DOOR & WINDOW HARDWARE CO., Taichung (TW)

(21) Appl. No.: 14/157,328

(22) Filed: Jan. 16, 2014

(51) Int. Cl. E05F 3/12; F16F 9/34

(52) U.S. Cl. CPC E05F 3/12; F16F 9/34

(57) ABSTRACT

A hydraulic cylinder impact-buffering assembly has an outer cylinder and a piston rod. The outer cylinder is a hollow tube and has an opening. The piston rod is movably connected to the outer cylinder and has a piston. The piston is securely connected to the piston rod, is movably mounted in the outer cylinder and has a connecting segment and a flowing segment. The connecting segment is securely connected to the piston rod and has a connecting recess, a ball recess, multiple side leaking holes, a leaking ball and a spring. The flowing segment is formed on and protrudes from the connecting segment and has a mounting recess, an oil ring, a central recess, multiple first guiding holes and multiple second guiding holes.

### BACKGROUND OF THE INVENTION

1. Field of the Invention

The present invention relates to a hydraulic cylinder impact-buffering assembly, and more particularly relates to a hydraulic cylinder impact-buffering assembly that can mitigate the impact phenomenon of the hydraulic cylinder impact-buffering assembly.

2. Description of Related Art

A conventional hydraulic cylinder buffering assembly has an outer cylinder and a piston rod. The outer cylinder is a hollow tube, is used to store hydraulic oil and has an inner diameter. The piston rod is movably connected to the outer cylinder and has an inner end, an outer end and a piston. The inner end of the piston rod is mounted in the outer cylinder. The outer end of the piston rod extends out of the outer cylinder. The piston is securely mounted on the inner end of the piston rod and has an outer diameter. The outer diameter of the piston is smaller than the inner diameter of the outer cylinder. When the piston rod is moved relative to the outer cylinder, the piston is moved with the piston rod relative to the outer cylinder to enable the hydraulic oil to move from one side to another side of the piston. When the hydraulic oil flows across the piston, a hydraulic pressure will be generated and provide a buffering effect to the piston rod.

In addition, the piston has a middle, an outer surface, a mounting recess, an oil ring and multiple guiding holes. The mounting recess is formed around the outer surface of the piston at the middle of the piston. The oil ring is mounted in the mounting recess of the piston and abuts an inner surface of the outer cylinder. The guiding holes are formed through the sides of the piston and communicate with the mounting recess of the piston. Furthermore, the guiding holes that are formed at the sides of the piston have different inner diameters, and this can enable the hydraulic oil to flow across the piston via the guiding holes having different inner diameters to provide different buffering forces to the piston rod when the piston rod is moved relative to the outer cylinder with different movement directions.

Although the conventional hydraulic cylinder buffering assembly can be used on a track to provide a buffering effect to a door via the piston rod, the conventional hydraulic cylinder buffering assembly is only applicable when the piston rod receives a relatively small external force to enable the hydraulic oil to flow smoothly between the guiding holes of different inner diameters. If the piston rod receives a relatively large external force, the hydraulic oil cannot flow across the piston from the guiding holes with small inner diameters to the guiding holes with large inner diameters in a short time, and this will cause an excessive speed difference between the piston rod and the door. Then, the speed of the door is rapidly reduced, thereby causing a strong vibration of the door or impact on the door. That is, when the piston rod receives a relatively large external force, the conventional hydraulic cylinder buffering assembly cannot provide a buffering effect to the piston rod. Therefore, the conventional hydraulic cylinder buffering assembly needs improvement.

To overcome the shortcomings, the present invention provides a hydraulic cylinder impact-buffering assembly to mitigate the aforementioned problems.

### SUMMARY OF THE INVENTION

The main objective of the present invention is to provide a hydraulic cylinder impact-buffering assembly that can mitigate the impact phenomenon of the hydraulic cylinder impact-buffering assembly.

The hydraulic cylinder impact-buffering assembly in accordance with the present invention has an outer cylinder and a piston rod. The outer cylinder is a hollow tube and has an opening. The piston rod is movably connected to the outer cylinder and has a piston. The piston is securely connected to the piston rod, is movably mounted in the outer cylinder, and has a connecting segment and a flowing segment. The connecting segment is securely connected to the piston rod and has a connecting recess, a ball recess, multiple side leaking holes, a leaking ball and a spring. The flowing segment is formed on and protrudes from the connecting segment and has a mounting recess, an oil ring, a central recess, multiple first guiding holes and multiple second guiding holes.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hydraulic cylinder impact-buffering assembly in accordance with the present invention;

FIG. 2 is a cross sectional view in partial section of the hydraulic cylinder impact-buffering assembly in FIG. 1;

FIG. 3 is an enlarged cross sectional view in partial section of the hydraulic cylinder impact-buffering assembly in FIG. 2;

FIG. 4 is an operational side view of the hydraulic cylinder impact-buffering assembly in FIG. 2 showing a piston rod is moved outwardly relative to an outer cylinder with hydraulic oil;

FIG. 4A is an enlarged perspective view of the hydraulic cylinder impact-buffering assembly in FIG. 4;

FIG. 5 is an operational side view of the hydraulic cylinder impact-buffering assembly in FIG. 2 showing the piston rod is moved inwardly relative to the outer cylinder of the hydraulic cylinder impact-buffering assembly by a relatively small external force;

FIG. 5A is an enlarged perspective view of the hydraulic cylinder impact-buffering assembly in FIG. 5;

FIG. 6 is an operational side view of the hydraulic cylinder impact-buffering assembly in FIG. 2 showing the piston rod is moved inwardly relative to the outer cylinder of the hydraulic cylinder impact-buffering assembly by a relatively large external force; and

FIG. 6A is an enlarged perspective view of the hydraulic cylinder impact-buffering assembly in FIG. 6.

### DETAILED DESCRIPTION OF PREFERRED EMBODIMENT

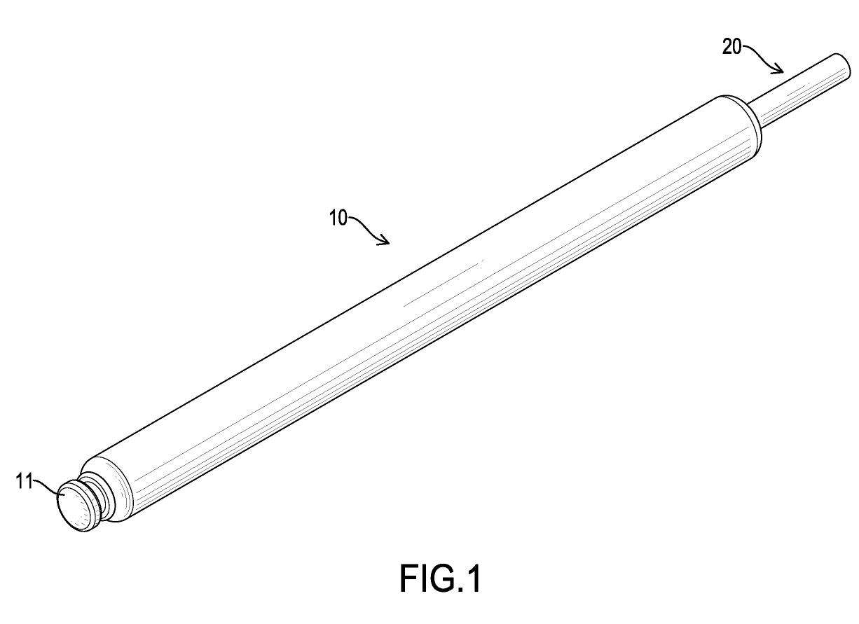

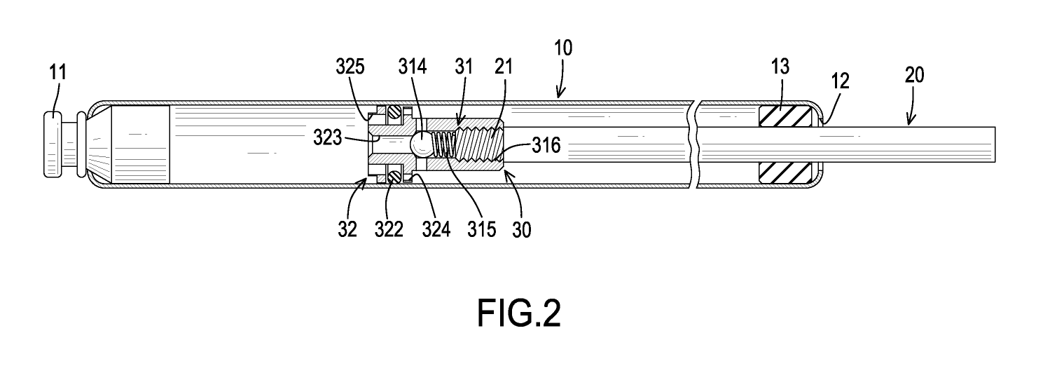

With reference to FIGS. 1 to 3, a hydraulic cylinder impact-buffering assembly in accordance with the present invention comprises an outer cylinder 10 and a piston rod 20.

The outer cylinder 10 is a hollow tube and has a distal end, a proximal end, an inner diameter, an internal surface, a connecting head 11, an opening 12 and a sealing block 13. The connecting head 11 is connected to the distal end of the outer cylinder 10. The opening 12 is formed through the proximal end of the outer cylinder 10. The sealing block 13 is mounted in the outer cylinder 10 and adjacent to the opening 12 to seal the opening 12.

The piston rod 20 is movably connected to the outer cylinder 10 and has an inner end, an outer end, an external surface, an outer thread 21 and a piston 30. The inner end of the piston rod 20 is movably mounted in the outer cylinder 10 via the opening 12 and the sealing block 13. The outer thread 21 is formed on the external surface of the piston rod 20 at the inner end of the piston rod 20.

The piston 30 is securely connected to the piston rod 20, is movably mounted in the outer cylinder 10 and has a connecting segment 31 and a flowing segment 32.

The connecting segment 31 is securely connected to the inner end of the piston rod 20 and has a connecting end, a forming end, an external surface, an outer diameter, a connecting recess 311, a ball recess 312, multiple side leaking holes 313, a leaking ball 314 and a spring 315. The connecting recess 311 is axially formed in the connecting end of the connecting segment 31, is mounted around and connected to the inner end of the piston rod 20, and has an internal surface and an inner thread 316. The inner thread 316 is formed on the internal surface of the connecting recess 311 and is screwed with the outer thread 21 of the piston rod 20. The ball recess 312 is axially formed in the forming end of the connecting segment 31 and communicates with the connecting recess 311.

The side leaking holes 313 are radially formed in the external surface of the connecting segment 31 at intervals and communicate with the ball recess 312. The leaking ball 314 is mounted in the ball recess 312 and between the side leaking holes 313. The spring 315 is mounted in the ball recess 312 and abuts the inner end of the piston rod 20 and the leaking ball 314 to enable the leaking ball 314 to locate between the side leaking holes 313.

The flowing segment 32 is formed on and protrudes from the forming end of the connecting segment 31 and has an outer diameter, a forming end, a flowing end, a middle, an external surface, a mounting recess 321, an oil ring 322, a central recess 323, multiple first guiding holes 324 and multiple second guiding holes 325. The outer diameter of the flowing segment 32 is larger than the outer diameter of the connecting segment 31. The forming end of the flowing segment 32 is formed with the forming end of the connecting segment 31. The mounting recess 321 is annularly formed in the external surface of the flowing segment 32 at the middle of the flowing segment 32 to form two flanges 326, 327 beside the mounting recess 321.

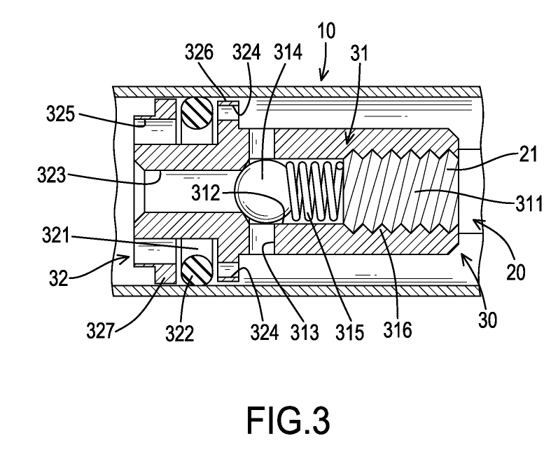

The flanges 326, 327 are respectively a first flange 326 and a second flange 327. The first flange 326 is formed on and protrudes from the external surface of the flowing segment 32 and between the mounting recess 321 and the side leaking holes 313 of the connecting segment 31. The second flange 327 is formed on and protrudes from the external surface of the flowing segment 32 and between the mounting recess 321 and the flowing end of the flowing segment 32. Furthermore, with reference to FIG. 3, the flanges 326, 327 are respectively located at an interval relative to the internal surface of the outer cylinder 10.

The oil ring 322 is mounted around the external surface of the flowing segment 32 in the mounting recess 321, abuts the internal surface of the outer cylinder 10 and selectively abuts the first flange 326 and the second flange 327 to enable hydraulic oil that is stored in the outer cylinder 10 to flow across the piston 30. The central recess 323 is axially formed through the forming end and the flowing end of the flowing segment 32, aligns with an axis of the flowing segment 32 and selectively communicates with the side leaking holes 313 when the leaking ball 314 is moved relative to the connecting segment 31. A passage between the central recess 323 of the flowing segment 32 and the side leaking holes 313 of the connecting segment 31 is closed by the leaking ball 314 that is pressed by the spring 315.

The first guiding holes 324 are radially formed through the first flange 326 at intervals, communicate with the mounting recess 321, and each one of the first guiding holes 324 has an inner diameter. The second guiding holes 325 are radially formed through the second flange 327 at intervals, communicate with the mounting recess 321, and each one of the second guiding holes 325 has an inner diameter. The inner diameters of the second guiding holes 325 are larger than the inner diameters of the first guiding holes 324. Additionally, when the hydraulic oil flows in the central recess 323 from the flowing end of the flowing segment 32, as the leaking ball 314 faces the side leaking holes 313, the hydraulic oil will flow out via the side leaking holes 313 without flowing across the leaking ball 314 and this can avoid the noise generated by the vibration of the leaking ball 314.

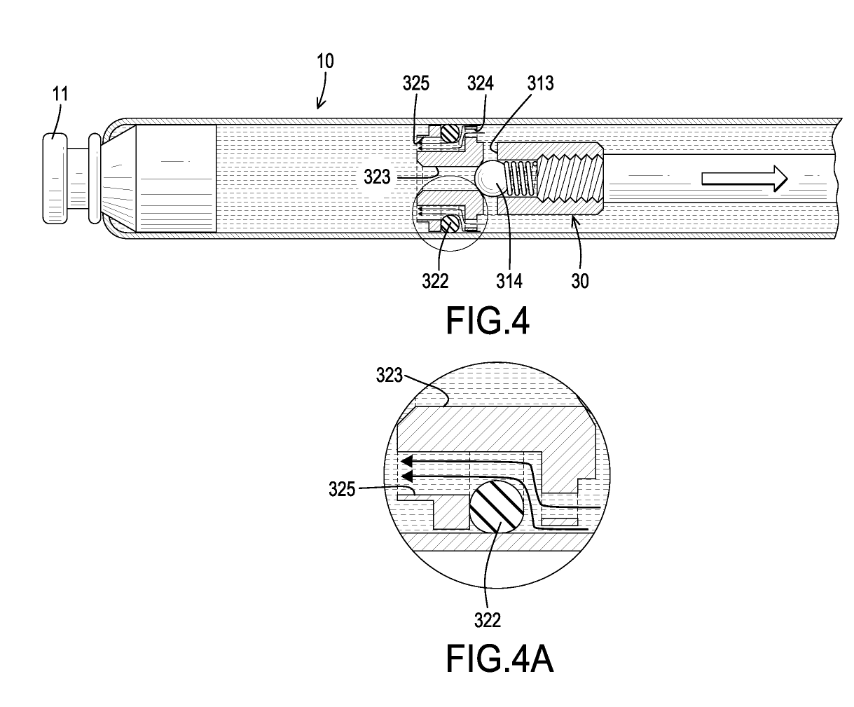

With reference to FIGS. 4 and 4A, in use, when the piston rod 20 of the hydraulic cylinder impact-buffering assembly in accordance with the present invention is connected to a door and is moved outwardly relative to the outer cylinder 10, the piston 30 is moved with the piston rod 20 relative to the outer cylinder 10. The oil ring 322 that is mounted in the mounting recess 321 abuts the second flange 327 of the flowing segment 32 by the abutment between the internal surface of the outer cylinder 10 and the oil ring 322. Then, the hydraulic oil that is located at the connecting end of the connecting segment 31 will flow to the flowing end of the flowing segment 32 via the first guiding holes 324, the interval between the first flange 326 and the internal surface of the outer cylinder 10, the mounting recess 321 and the second guiding holes 325. As the inner diameters of the second guiding holes 325 are larger than the inner diameters of the first guiding holes 324, the hydraulic oil flows quickly across the piston 30 from the connecting segment 31 to the flowing segment 32.

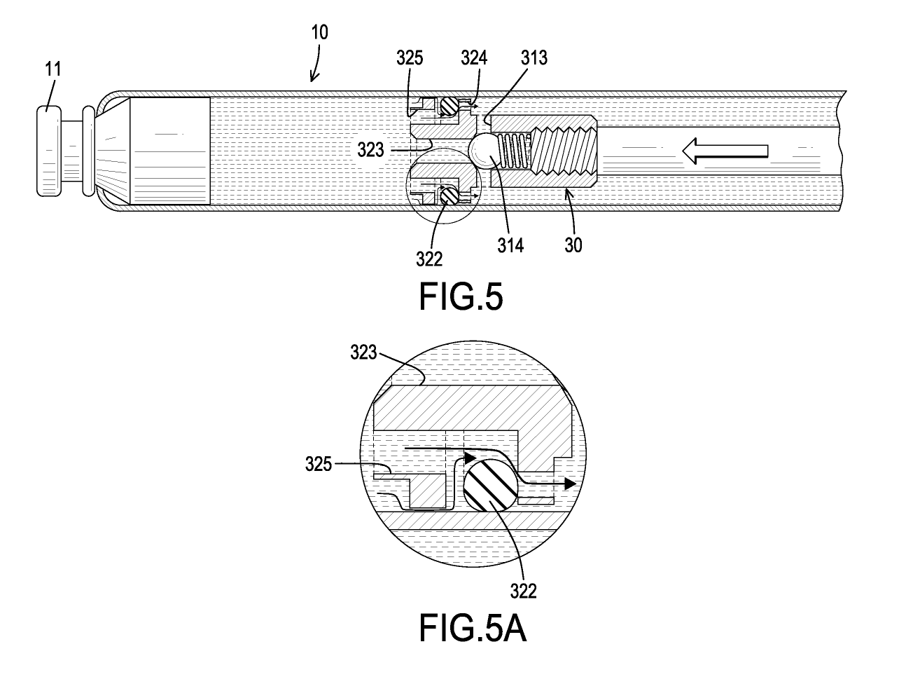

With reference to FIGS. 5 and 5A, when the piston rod 20 receives a relatively small external force and is moved inwardly relative to the outer cylinder 10, the piston 30 is moved with the piston rod 20 relative to the outer cylinder 10. The oil ring 322 that is mounted in the mounting recess 321 abuts the first flange 326 of the flowing segment 32 by the abutment between the internal surface of the outer cylinder 10 and the oil ring 322. Then, the hydraulic oil that is located at the flowing end of the flowing segment 32 will flow to the connecting end of the connecting segment 31 via the second guiding holes 325, the interval between the second flange 327 and the internal surface of the outer cylinder 10, the mounting recess 321 and the first guiding holes 324. As the inner diameters of the first guiding holes 324 are smaller than the inner diameters of the second guiding holes 325, the hydraulic oil flows slowly across the piston 30 from the flowing segment 32 to the connecting segment 31 to generate a hydraulic pressure to provide a buffering effect to the piston rod 20.

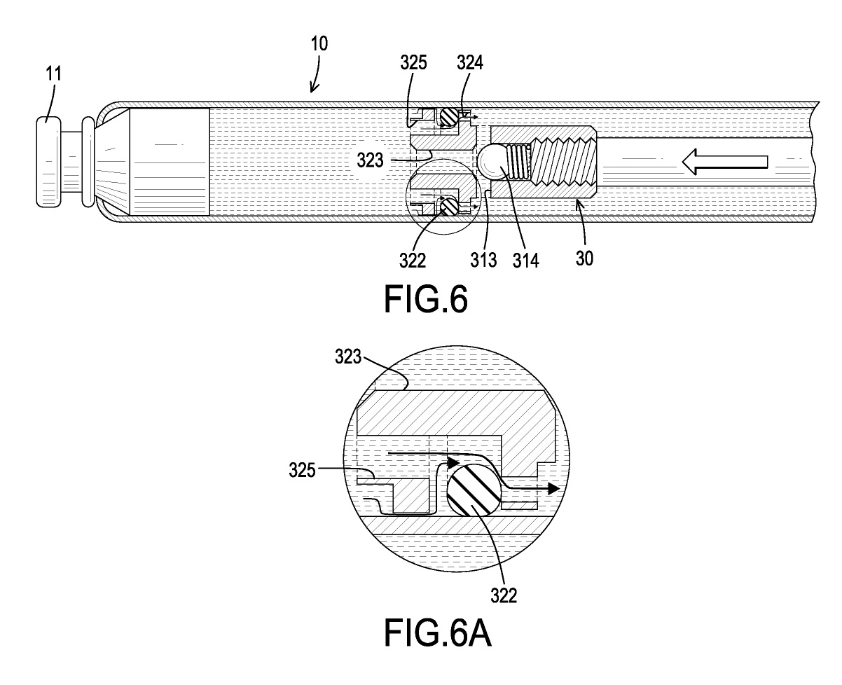

With reference to FIGS. 6 and 6A, when the piston rod 20 receives a relatively large external force and is moved inwardly relative to the outer cylinder 10, the piston 30 is moved with the piston rod 20 relative to the outer cylinder 10. The oil ring 322 that is mounted in the mounting recess 321 abuts the first flange 326 of the flowing segment 32 by the abutment between the internal surface of the outer cylinder 10 and the oil ring 322. Then, the hydraulic oil that is located at the flowing end of the flowing segment 32 will flow to the connecting end of the connecting segment 31 via the second guiding holes 325, the interval between the second flange 327 and the internal surface of the outer cylinder 10, the mounting recess 321 and the first guiding holes 324.

However, the hydraulic pressure of the hydraulic oil that flows across the piston 30 via the second guiding holes 325, the interval between the second flange 327 and the internal surface of the outer cylinder 10, the mounting recess 321 and the first guiding holes 324 is not sufficient to overcome the pressure of the relatively large external force. The excessive pressure of the relatively large external force will enable the hydraulic oil to push the leaking ball 314 via the central recess 323 to move toward the inner end of the piston rod 20 to compress the spring 315 and to enable the side leaking holes 313 to communicate with the central recess 323. Then, the hydraulic oil that is located at the flowing end of the flowing segment 32 also can flow to the connecting end of the connecting segment 31 via the passage between the central recess 323 and the side leaking holes 313. Therefore, when the piston rod 20 receives a relatively large external force, the hydraulic oil can flow across the piston 30 from the flowing segment 32 to the connecting segment 31 via the second guiding holes 325, the interval between the second flange 327 and the internal surface of the outer cylinder 10, the mounting recess 321 and the first guiding holes 324 and also via the central recess 323 and the side leaking holes 313.

In addition, when the hydraulic pressure of the hydraulic oil is reduced to a certain extent, the compressed spring 315 will push the leaking ball 314 to move backwardly to the original position to close the passage between the central recess 323 and the side leaking holes 313. Consequently, when the piston rod 20 of the hydraulic cylinder impact-buffering assembly in accordance with the present invention receives a large external force, the hydraulic oil can still flow smoothly in the outer cylinder 10 and also can provide a buffering effect to the door via the piston rod 20 to prevent an excessive speed difference between the piston rod 20 and the door, thereby avoiding strong vibrations of the door or impact on the door.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hydraulic cylinder impact-buffering assembly comprising:
an outer cylinder, the outer cylinder being a hollow tube and having a distal end, a proximal end and an opening formed through the proximal end of the outer cylinder; and
a piston rod, the piston rod movably connected to the outer cylinder and having an inner end movably mounted in the outer cylinder via the opening, an outer end, an external surface and a piston, the piston securely connected to the piston rod, movably mounted in the outer cylinder and having a connecting segment and a flowing segment, the connecting segment securely connected to the inner end of the piston rod and having a connecting end, a forming end, an external surface, an outer diameter, a connecting recess, a ball recess, multiple side leaking holes, a leaking ball and a spring, the connecting recess axially formed in the connecting end of the connecting segment, mounted around and connected to the inner end of the piston rod, the ball recess axially formed in the forming end of the connecting segment and communicating with the connecting recess, the side leaking holes radially formed in the external surface of the connecting segment at intervals and communicating with the ball recess, the leaking ball mounted in the ball recess between the side leaking holes, the spring mounted in the ball recess and abutting the inner end of the piston rod and the leaking ball to enable the leaking ball to locate between the side leaking holes, the flowing segment formed on and protruding from the forming end of the connecting segment and having an outer diameter larger than the outer diameter of the connecting segment, a forming end formed with the forming end of the connecting segment, a flowing end, a middle, an external surface, a mounting recess, an oil ring, a central recess, multiple first guiding holes and multiple second guiding holes, the mounting recess annularly formed in the external surface of the flowing segment at the middle of the flowing segment to form a first flange and a second flange beside the mounting recess, the first flange formed on and protruding from the external surface of the flowing segment between the mounting recess and the side leaking holes of the connecting segment, the second flange formed on and protruding from the external surface of the flowing segment between the mounting recess and the flowing end of the flowing segment, the oil ring mounted around the external surface of the flowing segment in the mounting recess, abutting the internal surface of the outer cylinder and selectively abutting the first flange and the second flange, the central recess axially formed through the forming end and the flowing end of the flowing segment, aligning with an axis of the flowing segment and selectively communicating with the side leaking holes when the leaking ball is moved relative to the connecting segment, the first guiding holes radially formed through the first flange at intervals, communicating with the mounting recess, and each one of the first guiding holes having an inner diameter, and the second guiding holes radially formed through the second flange at intervals, communicating with the mounting recess, and each one of the second guiding holes having an inner diameter different from the inner diameter of each one of the first guiding holes.

2. The hydraulic cylinder impact-buffering assembly as claimed in claim 1, wherein the inner diameter of each one of the second guiding holes is larger than the inner diameter of each one of the first guiding holes.

3. The hydraulic cylinder impact-buffering assembly as claimed in claim 2, wherein
the outer cylinder has a sealing block mounted in the outer cylinder and adjacent to the opening to seal the opening; and
the inner end of the piston rod is movably mounted in the outer cylinder via the opening and the sealing block.

4. The hydraulic cylinder impact-buffering assembly as claimed in claim 3, wherein the outer cylinder has a connecting head connected to the distal end of the outer cylinder.

5. The hydraulic cylinder impact-buffering assembly as claimed in claim 4, wherein
the piston rod has an outer thread formed on the external surface of the piston rod at the inner end of the piston rod; and
the connecting recess of the connecting segment has an internal surface and an inner thread formed on the internal surface of the connecting recess and screwed with the outer thread of the piston rod.

6. The hydraulic cylinder impact-buffering assembly as claimed in claim 5, wherein
the leaking ball is mounted in the ball recess to abut against the forming end of the flowing segment to close a passage between the central recess of the flowing segment and the side leaking holes of the connecting segment; and
the spring is mounted between the leaking ball and the inner end of the piston rod.

7. The hydraulic cylinder impact-buffering assembly as claimed in claim 1, wherein
the outer cylinder has a sealing block mounted in the outer cylinder and adjacent to the opening to seal the opening; and
the inner end of the piston rod is movably mounted in the outer cylinder via the opening and the sealing block.

8. The hydraulic cylinder impact-buffering assembly as claimed in claim 1, wherein the outer cylinder has a connecting head connected to the distal end of the outer cylinder.

9. The hydraulic cylinder impact-buffering assembly as claimed in claim 2, wherein the outer cylinder has a connecting head connected to the distal end of the outer cylinder.

10. The hydraulic cylinder impact-buffering assembly as claimed in claim 1, wherein
the piston rod has an outer thread formed on the external surface of the piston rod at the inner end of the piston rod; and
the connecting recess of the connecting segment has an internal surface and an inner thread formed on the internal surface of the connecting recess and screwed with the outer thread of the piston rod.

11. The hydraulic cylinder impact-buffering assembly as claimed in claim 2, wherein
the piston rod has an outer thread formed on the external surface of the piston rod at the inner end of the piston rod; and
the connecting recess of the connecting segment has an internal surface and an inner thread formed on the internal surface of the connecting recess and screwed with the outer thread of the piston rod.

12. The hydraulic cylinder impact-buffering assembly as claimed in claim 3, wherein
the piston rod has an outer thread formed on the external surface of the piston rod at the inner end of the piston rod; and
the connecting recess of the connecting segment has an internal surface and an inner thread formed on the internal surface of the connecting recess and screwed with the outer thread of the piston rod.

13. The hydraulic cylinder impact-buffering assembly as claimed in claim 1, wherein
the leaking ball is mounted in the ball recess to abut against the forming end of the flowing segment to close a passage between the central recess of the flowing segment and the side leaking holes of the connecting segment; and
the spring is mounted between the leaking ball and the inner end of the piston rod.

14. The hydraulic cylinder impact-buffering assembly as claimed in claim 2, wherein
the leaking ball is mounted in the ball recess to abut against the forming end of the flowing segment to close a passage between the central recess of the flowing segment and the side leaking holes of the connecting segment; and
the spring is mounted between the leaking ball and the inner end of the piston rod.

15. The hydraulic cylinder impact-buffering assembly as claimed in claim 3, wherein
the leaking ball is mounted in the ball recess to abut against the forming end of the flowing segment to close a passage between the central recess of the flowing segment and the side leaking holes of the connecting segment; and
the spring is mounted between the leaking ball and the inner end of the piston rod.

16. The hydraulic cylinder impact-buffering assembly as claimed in claim 4, wherein
the leaking ball is mounted in the ball recess to abut against the forming end of the flowing segment to close a passage between the central recess of the flowing segment and the side leaking holes of the connecting segment; and
the spring is mounted between the leaking ball and the inner end of the piston rod.
